(19) United States
(12) Patent Application Publication
(10) Pub. No.: US 2011/0053449 A1
(43) Pub. Date: Mar. 3, 2011

(54) Multipurpose Laminated Stretch Fabric

(75) Inventor: Sachin Hanmant Kulkarni, Mumbai (IN)

(73) Assignee: Welspun Global Brands Limited, Mumbai (IN)

(21) Appl. No.: 12/861,083

(22) Filed: Aug. 23, 2010

(30) Foreign Application Priority Data
Aug. 25, 2009 (IN) 1955/MUM/2009

(51) Int. Cl. B32B 5/02; B32B 39/00

(52) U.S. Cl. 442/182; 156/494

(57) ABSTRACT

The current invention relates to a multifunctional and multipurpose laminated stretch fabric suitable for home textiles, upholstery and apparels and other personal and industrial applications comprising at least one non-stretchable or easily deformable fabric element (10) adhesively bound to a stretchable membrane element (20) on at least one side. The invention also relates to the assembly for manufacturing the said laminate and the process for production thereof.

### FIELD OF INVENTION

The present invention relates generally to a multipurpose laminated stretch fabric. More particularly, the instant invention relates to a textile material comprising fabric with specific construction and made of spun staple fiber or filament yarns, but without any stretchable component. The fabric is laminated with stretchable membrane, on at least one face under specific conditions of pressure thereby resulting into a stretchable material accompanied by good recovery from stretch. The process for production and apparatus thereof are also described.

### BACKGROUND OF INVENTION

Stretch fabric is a term that refers to natural and synthetic material fabrics which stretch in required direction. This is in contrast to normal fabrics that will often extend to a small extent, although in only two directions.

Stretch fabrics evolved from the scientific effort to make fibers using neoprene. From this research, in 1958 commercial stretch fibers (‘elastomerics’) such as spandex or elastane (widely branded as ‘Lycra’) were brought to the market.

Stretch fabrics simplify the construction of clothing. First used in swimsuits and women's bra, fashion designers began using them as early as the mid-1980s. They entered the mainstream market in the early 1990s, and are widely used in sportswear.

On a larger scale, the materials have also been adapted to many artistic and decorative purposes. Stretch fabric structures create contemporary and modern looking design elements that have many uses in corporate theatre and event production management.

Currently, stretch fabrics are manufactured either from woven or knitted ones. Stretchable yarns currently in market are either spun yarns or filament yarns. Spun yarns are produced using core spinning technology. Spandex or Lycra filaments are most commonly used as elastic core and are surrounded by staple fibers. Most common staple fibers used are cotton or polyester or viscose rayon or combination. Stretch in final yarn is controlled through weight compositions of core and covering sheath.

The earliest, probable, disclosure of core spun yarns was made in U.S. Pat. No. 1,373,880 dated Dec. 2, 1919 and granted on Apr. 5, 1921, the inventor being Israel Garon. The said patent claims a yarn which is combination of elastic rubber core and cover of other material spun around the core (core spun technology). Numerous subsequent patents such as, U.S. Pat. No. 2,024,156, U.S. Pat. No. 2,210,884, U.S. Pat. No. 2,313,058, U.S. Pat. No. 2,504,523, U.S. Pat. No. 2,526,523, U.S. Pat. No. 3,017,740, U.S. Pat. No. 3,038,295, GB1262766, U.S. Pat. No. 4,481,759, U.S. Pat. No. 5,555,716, U.S. Pat. No. 7,310,932, JP2009001951, DE3405209, CN101307523, CN101270519 disclose various versions of core spun yarns and processes for their production. Generally, stretch filaments are produced using air texturing method. CN101418489, CN101130910, JP2007051394 disclose the use of such technique for manufacturing of stretch fabric. Elastic core is invariably a spandex or Lycra and is intermingled with other non-stretch filaments in required ratio to generate necessary stretch in the final yarn.

The yarn manufacturing routes, as disclosed in any of above mentioned prior arts, are complicated and very expensive. They demand special care throughout manufacturing process, skilled and trained workforce is required to handle this manufacturing. Covering components, namely, staple fibers in case of core spinning and non stretch filaments in case of air texturing need to be of a high grade. Amount of twist level needs to be lowered so as to avoid twisting of core stretchable component. This calls for a use of long and strong fibers or high strength of filaments which adds to manufacturing cost.

Commercially available stretchable core filaments are in the range of 20 Dtex to 110 Dtex. This poses a limit, particularly on the spinning of fine yarn counts. Therefore, fabric with 60 g/m², using finer stretch yarns like Ne 80/1 or Ne 100/1 is not possible.

Once yarns are spun they require proper stabilization by using super saturated steam for core spun yarns and hot air heat setting for air textured filaments which adds to cost. A close monitoring of conditions is must; else a hampered performance and increased fabric faults are witnessed. Fabric manufacturing also calls for special precautions and monitoring. Further, the current manufacturing process leads to reduced production speeds, making the whole process, as such, less economical. Fabric defect levels are also on higher side, this adds to a higher value loss.

Specific care needs to be taken while selecting fabric chemical/mechanical finishing routes and chemicals. Further, with these fabrics, it is very difficult to achieve required residual shrinkage. Sometimes, prior to shrinkage, heat setting and reduction of stretchability of the fabric becomes essential. Furthermore, these fabrics rarely give a flat and clean look.

U.S. Pat. No. 4,761,324 discloses an elastic laminate having a layer of stretch material having substantial elastic qualities, a polymer film layer being breathable, water-resistant and having elastic qualities, and an adhesive present in substantially discontinuous segments bonding said film layer to said material. The Base fabric used is made of combination of non stretchable and stretchable yarns, leading to complicated and costly process. Base fabric has to go through the difficult and costly process route. Process disclosed herein is only for synthetics like nylon base fabric. Such fabrics are mostly suitable as outer wear or protective wear—for skiing and sports wear. As such, the invention herein is limited to stretch yarn for base fabric.

U.S. Pat. No. 4,935,287 (Johnson et al.) describes stretchable laminate constructions based on an elastic fabric and a substantially non-elastic film which are held in intimate contact with one another by means of a non-continuous pattern of adhesive. When the laminate constructions of the invention are in a relaxed state, the length of the film between adjacent adhesion points in the direction of stretch of the elastic fabric is essentially equivalent to the length of the elastic fabric between the same adhesion points when the construction is extended to its elastic recovery limit. A preferred embodiment of the invention utilizes waterproof breathable non-elastic membranes to produce laminate constructions suitable for clean room and protective garment applications. The breathable material of this invention provides stretch properties only in the machine direction. The invention as disclosed in U.S. Pat. No. '287 uses woven or non-woven stretchable base fabric which makes the process complicated and costly. The Stretchable fabric has to form folds when relaxed which could result into high unwanted thickness. This phenomenon also results in discontinuous surface resulting into different look and feel. This limits scope of application, that is, if one desires to make a formal wear out of this fabric, it is not possible. Also, wash durability could be an issue, thereby, limiting the scope for applications.

U.S. Pat. No. 5,804,011 discloses a stretchable layered fabric laminate which is air impermeable and waterproof while being permeable to water vapor. The stretchable fabric laminate includes a stretchable composite material layer consisting of a hydrophobic protective layer of a porous polymeric material on each side of a layer of hydrophilic water-vapor-permeable synthetic polymer. The composite material layer is laminated to at least one layer of stretchable fabric. The invention described herein also needs a stretchable fabric which results in complicated process and high cost, even though the stretchable layered fabric has good stretch and recovery properties.

As seen from above prior arts, there is need for cost effective and easy to manufacture fabric, which does not involve use of stretchable fabric.

Instant invention provides enlisted advantages over prior art. Firstly, the finished fabric is done separately without any complications and stretchability is inculcated in this finished fabric in the later stage. This helps achieve simple process, unlimited scope for fabric selection. Original attributes of the fabric are also retained. Secondly, process is flexible enough to construct a specific fabric, thereby enabling high deformation under low load. This fabric construction along with stretchable membrane results into stretch and recovery from stretch and lastly, the stretchable membrane and the fabric are pre-stressed to a required level so that it results into catapult effect and thereby one can maximize stretch behavior in the final product.

### OBJECT OF INVENTION

The main object of the invention is to provide a novel multipurpose laminated stretch fabric comprising of non-stretchable fabric element bound adhesively to a stretchable membrane element and the cost effective process for manufacture thereof.

Another object of the invention is to provide a complete flexibility and normalcy in its original form during fabric manufacturing and finishing process and chemical selection.

Yet another object of the invention is to provide a of fabric with low weights like 80 g/m² using finer yarns like Ne 60/1 or Ne 80/1.

Further another object of the invention is to provide a fabric with one water absorbent surface and remote water repellent surface to provide properties like barrier to water or liquids and if required to air and vapor.

It is also object of the invention is to improve wrinkle behavior, strength and durability of fabric.

### SUMMARY OF INVENTION

In accordance with the above objective the present invention provides a novel multipurpose laminated stretch fabric suitable for application in stretchable gusset fabric, mattress shell fabric, pillow shell fabric, stretchable apparel fabrics and in general for all those applications where stretch and good recovery form stretch is required.

The stretchable textile material of instant invention comprises a fabric with non stretch yarns but with suitable construction, together with elastic membrane fulfils the requirement for being transformed into stretchable fabric. Further, fabric is laminated on at least one side with elastic membrane. Both components are able to retain or rather enhance their original properties. Bonding adhesive is selected accordingly.

Fabric is woven or knitted. The fabric, at outset is dyed and processed so that it will have all look and feel attributes suitable for intended application. Membrane selection is done based on functions expected in the final product.

### BRIEF DESCRIPTION OF THE DRAWINGS

The invention may be better understood by references to the detailed description when considered in connection with the accompanying drawings. The components in the figures are not necessarily to scale, emphasis instead being placed upon illustrating the principles of the invention. In the figures, like reference numerals designate corresponding parts throughout the different views.

FIG. 1 describes the lamination assembly in its entirety.

FIGS. 2a and 2b show stretch material of invention in un-tensioned and tensioned condition respectively.

FIGS. 3, 4 and 5 describe various processes that can be used for manufacturing the product of instant invention.

FIG. 6 shows membrane thickness after lamination.

FIG. 7 shows Scanning electron micrograph of woven fabric stretch material.

FIG. 8 shows Scanning electron micrograph of knitted fabric stretch material.

FIG. 9 shows Scanning electron micrograph of sandwiched stretch material.

FIGS. 10a and 10b show the stretch behavior.

### DETAILED DESCRIPTION OF THE DRAWINGS

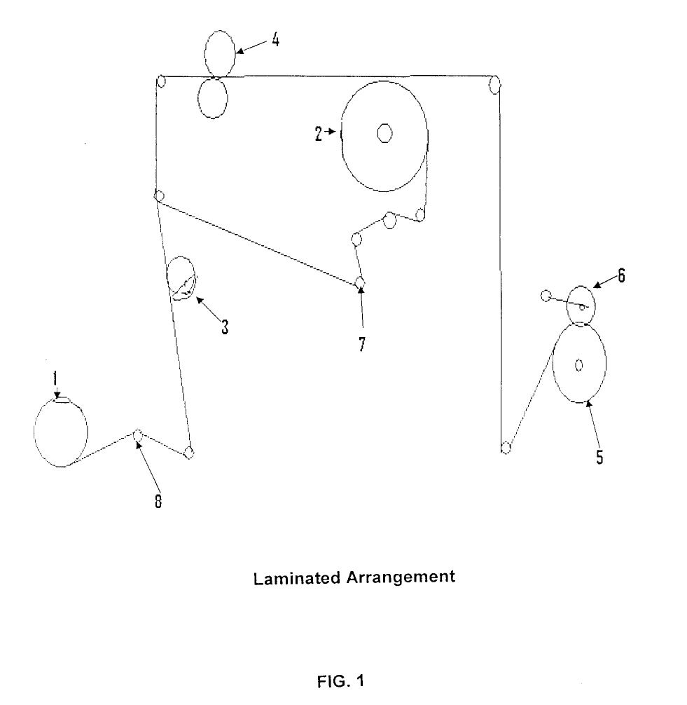

The assembly as shown in FIG. 1 which is used for manufacture of the laminate of instant invention comprises a stretchable membrane roll 1 consisting of fine stretchable membrane layered with release paper. The membrane from the roll 1 is pre-tensioned to the required level using tensioning device 8. Suitable adhesive is applied to pre-tensioned membrane by applicator roll 3, the adhesive in maintained in the trough below the applicator roll 3. The applicator roll 3 has engraved surface. The grooves carry a pre-determined quantity of adhesive which is applied on stretchable membrane.

The assembly as in FIG. 1 further comprises a fabric roll 2. The fabric from the roll 2 is tensioned by tensioning device 7. Fabric is opened up and not allowed to wrinkle by fabric expander. The pre-tensioned fabric from roll 2 tensioned by assembly 7 and the pre-tensioned stretchable membrane from roll 1 tensioned by assembly 8 are pressed together, under desired pressure by lamination rolls assembly 4. The adhesive as used in above process cross-links at room temperature and further develops adequate and flexible bonding between fabric and membrane, within 48 to 72 hours. After cross-linking is complete the release paper is removed away and the fabric is ready for use.

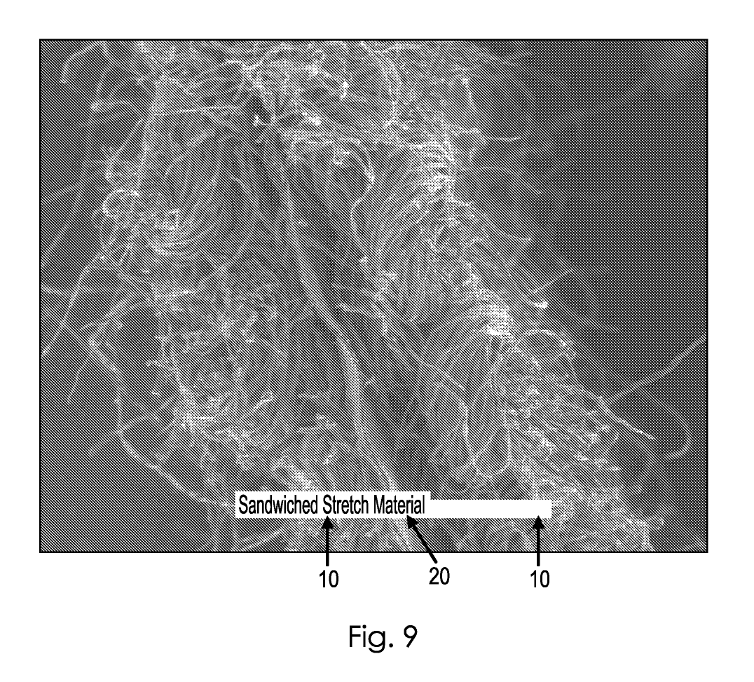

Two fabrics can be laminated together with membrane 20 sand witched in between as shown in FIG. 9.

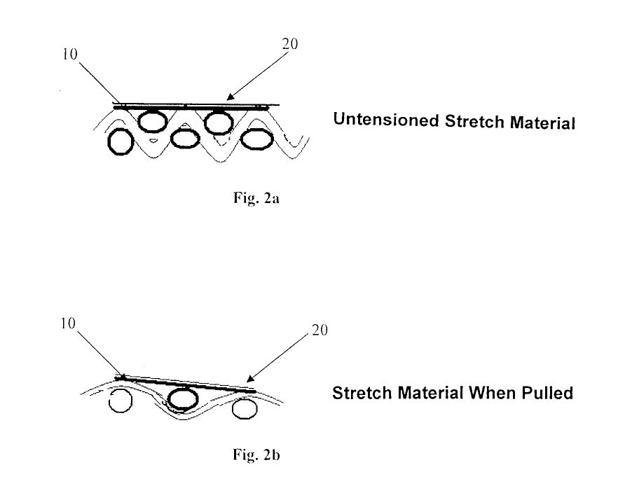

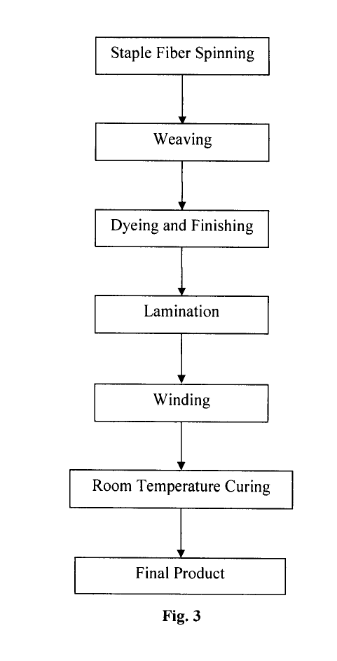

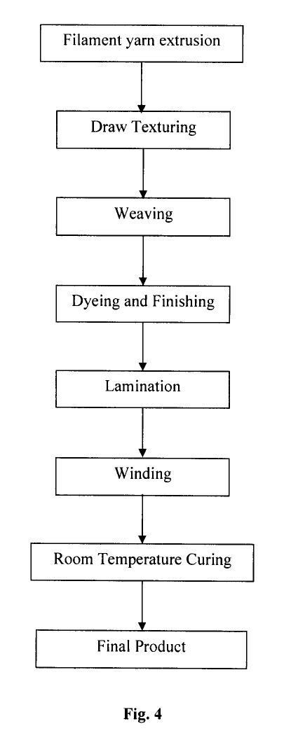

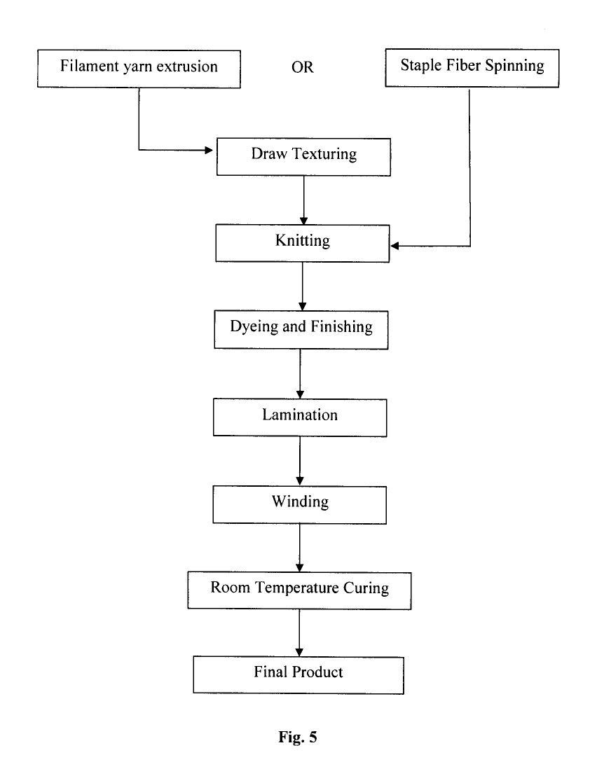

FIGS. 2a and 2b show the laminate of instant invention in relaxed and in stretched condition respectively, wherein non-stretchable element 10 is laminated to stretchable element 20 using an adhesive selected from polyurethane or thermoplastic polyurethane. The non-stretchable element 10 is constructed from woven easily deformable fabric comprising openly spaced warp ends intersecting at right angles with a plurality of more openly and parallelly spaced apart well yarns, or knitted fabric having a single jersey or interlock construction. The stretchable element 20 is made form elastic polymer like polyurethane or thermoplastic polyurethane. The said membrane when relaxed has a thickness of 20 microns to 40 microns and weight in range of 25 g/m² to 40 g/m²

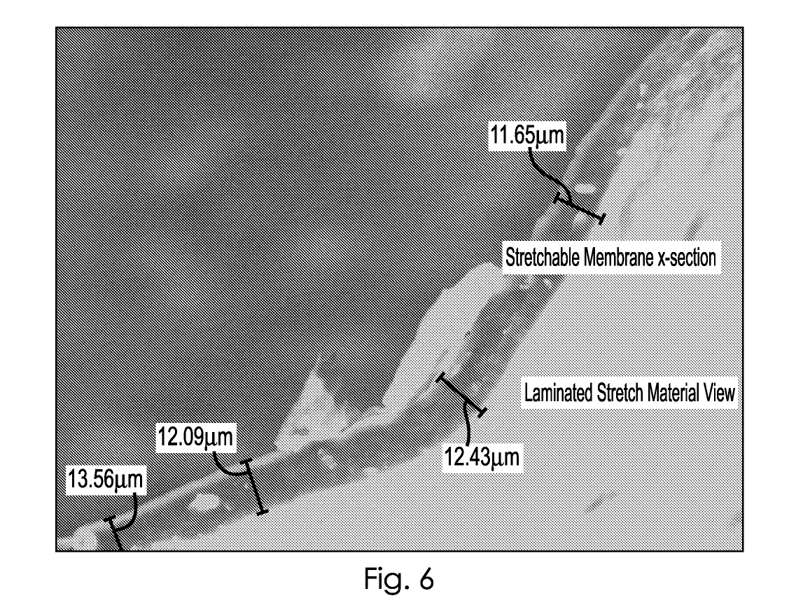

FIG. 6 indicates the membrane thickness reduces to an average of 12 microns as the lamination is carried out under tension. The thickness of original membrane in relaxed state was 20 microns.

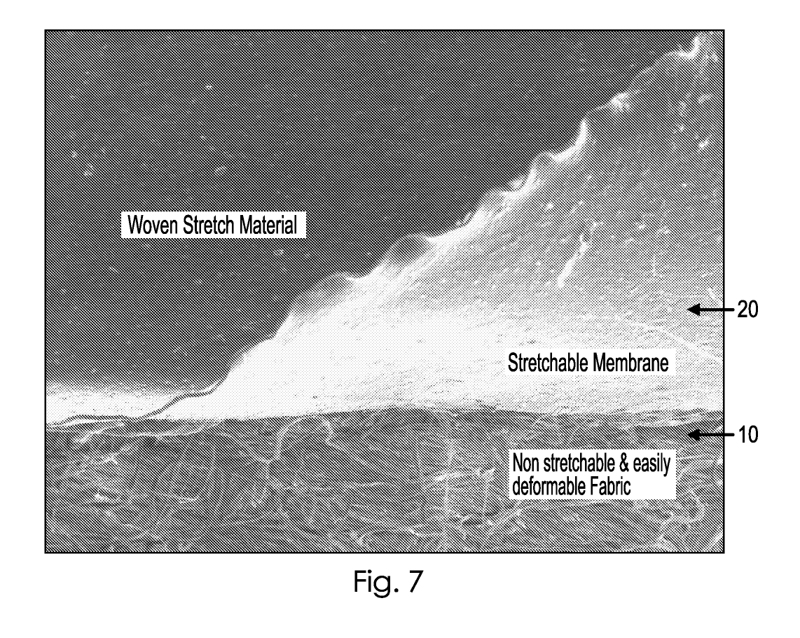

FIG. 7 depicts one of the embodiments of instant invention wherein the non-stretchable element (10) comprises non-stretchable, easily deformable fabric made from woven fabric laminated to stretchable membrane 20

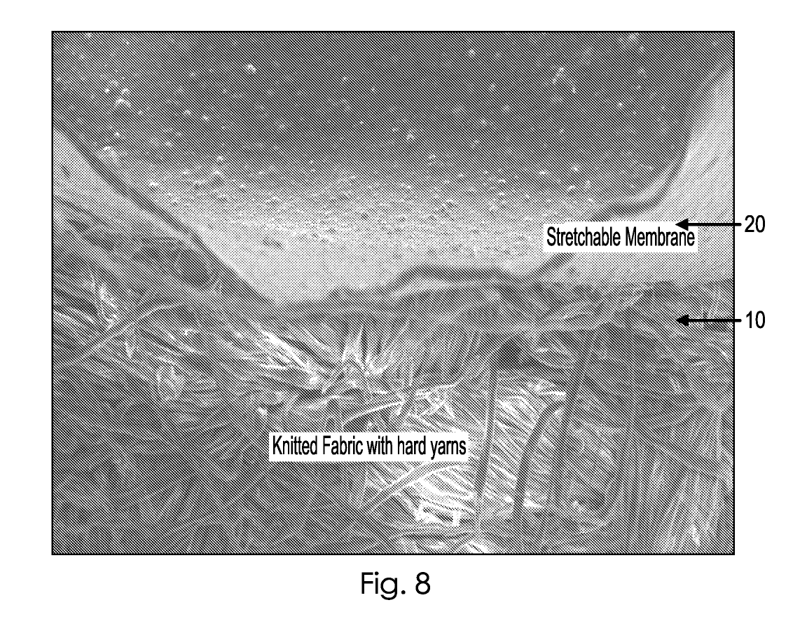

FIG. 8 depicts one of the embodiments of instant invention wherein the fabric element (10) comprises non-stable fabric made from knitted fabric laminated to stretchable membrane 20

FIG. 9 depicts one of the embodiments of instant invention wherein the stretchable element 20 is sandwiched between two non-stable fabric (10) layers. The fabric layers are made up of either a woven fabric or knitted fabric.

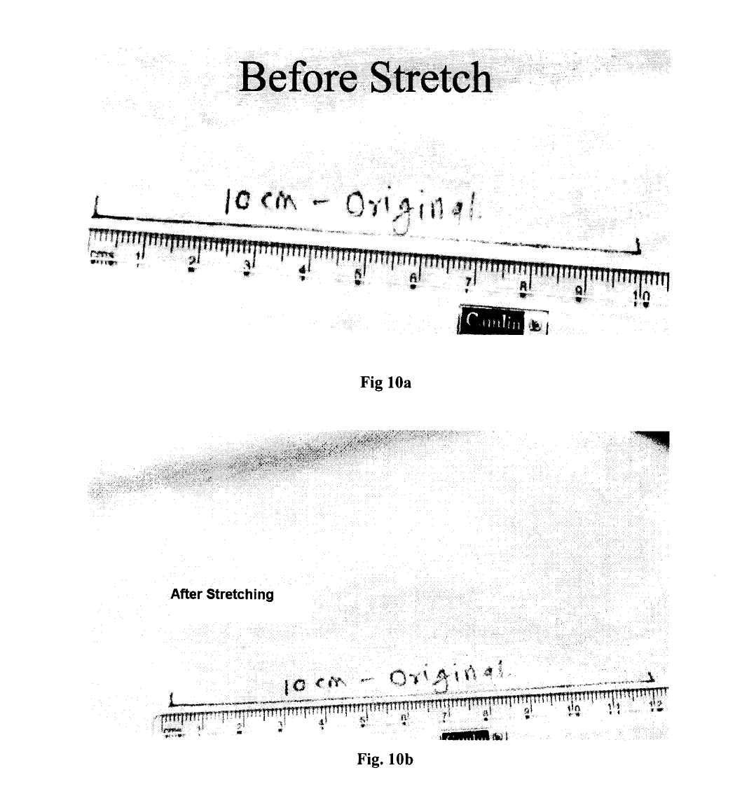

FIGS. 10a and 10b depict the stretch which has been incorporated in the laminate of invention. The stretch in the drawing is depicted by drawing a line of length 10 cm on a relaxed fabric as in FIG. 10a, which increases to 12 cm on application of a load, as in FIG. 10b. The stretch recorded is about 20%.

### DETAILED DESCRIPTION OF INVENTION

The invention will now be described in details in connection with certain preferred and optional embodiments so that various aspects thereof may be more fully understood and appreciated. The drawings and discussions are presented with the understanding that the present disclosure is an exemplification of the principles of one or more inventions and is not intended to limit any one of the inventions to the embodiments illustrated.

“Multipurpose laminated stretchable fabric” or “laminate” or “stretchable laminate” are used interchangeably in for the purpose of instant invention, which comprises of at least one layer of non-stretch fabric laminated on at least one side with a at least one polymeric elastic membrane and are bonded together by adhesive.

“Non-stretchable element” or “non-stretchable fabric” or “non-stretchable fabric element”, “non-stable fabric” are used interchangeably for the purpose of instant invention, relates to a layer of fabric manufactured using non-stretchable yarns.

“Stretchable element” or “stretchable membrane” or “stretchable membrane element” are used interchangeably for the purpose of instant invention, relates to a layer of stretchable membrane manufactured from elastic polymer.

The present invention provides a multipurpose laminated stretchable fabric formed by binding of at least one non-stretchable fabric layer laminated to at least one elastic polymeric layer bound together by an adhesive. The polymeric layer as used herein is selected from polyurethane or thermoplastic polyurethane.

The instant invention can be used for all applications of clothing and home textiles, natural and/or synthetic material, woven and/or knitted fabric. No requirement of stretch yarns for base fabric which results in a simple and cost effective process. Unlike product used herein before, which generally involved use of stretchable yarn or a combination of stretchable and non-stretchable yarn to inculcate the stretchability in fabric wherein, the use of stretchable fabric complicates the process for manufacturing thereby increasing the production cost.

Further instant invention delivers a cost effective and easy to manufacture fabric. This fabric has look and feel of regular fabric, unlike already available laminates, thereby increasing the suitability of fabric for any kind of applications in apparel, home textiles and inner/outer performance wear.

In an embodiment, the instant invention provides a laminate having enlisted advantages over prior art firstly, the finished fabric is done separately without any complications and the stretchability is inculcated in this finished fabric at the later stage. This helps in simplifying the process and opens up a scope for fabric selection. Original attributes of the fabric are also retained. Secondly, process can be customized to produce a fabric with specific construction, thereby enabling high deformation under low load. Example: Plain woven fabric with Ne 40×40 with 170×76 constructions in warp and weft way direction respectively. During Tensile Test in weft way direction, till the load is increased up to 4 lb, fabric shows increase in length of 0.3 mm and after removal of this load, there is a 100% recovery. In contrast to this, under same load of 4 lb, easily deformable woven fabric shows increase in length of 8 to 10 mm. After removal of this load, recovery is hardly 10 to 12%. This kind of fabric construction along with stretchable membrane results into stretch and recovery from stretch. Lastly, the stretchable membrane and the fabric are pre-stressed to a required level so that it results into catapult effect and thereby one can maximize stretch behavior in the final product.

The non-stretchable/non-stable fabric layer is either woven or knitted or in combination with non-woven fabric. The yarns, as used in the construction of said non-stretchable/non-stable fabric layer do not posses the core of elastic fiber or filament, such as, spandex or Lycra. The absence of the core denies the fabric off stretchability. The non-stretchable fabric of instant invention is so constructed such that there is a predetermined reduction in end density and pick density. For example, with plain woven fabrics, in order to get this behavior in weft direction, warp end density is required to be reduced by 10% to 25% and weft density is required to be reduced by 35% to 50%.

For purpose of invention, the stretchable membrane, which is laminated, on at least one face of the non-stretchable/non-stable layer, is selected from polyurethane or thermoplastic polyurethane. Other polymers possessing elastic property can also be used given that the polymer satisfies conditions of polymer chemistry, molecular chain orientation, thickness and/or density which play a vital role in depicting elastic behavior. For example, the stretch fabric to be used in fitted sheet or gussets, a Thermoplastic Polyurethane Membrane with the thickness in range of 20 to 50 microns along with a weight in range of 25 to 40 g/m² is suitable.

The laminate of instant invention is constructed by laminating the easily deformable, non-stretchable fabric layer with the elastic membrane. The bonding is affected by applying adhesives selected from polyurethane or thermoplastic polyurethane between the layers and further pressing the two together at appropriate pressure.

Wherever fabric is required to be used from both sides, stretchable membrane is sandwiched and laminated between two fabrics. Fabric construction and membrane selection is done accordingly.

When stretched under a load of 4 lb, the laminate as constructed by above method shows a length increase to an extent allowed mainly by deformation limit of the fabric and yarn elastic extension, to some extent by crimp interchange. This is termed as stretch. After removal of this load the fabric recoils towards original length, which is affected by transformation of potential energy of stretchable membrane and also, of yarns in fabric into kinetic energy. This is called as recovery. Stretch which is not recovered is called as growth.

Non stretchable 100% cotton woven product with Ne 40×40 with 170×76 constructions in warp and weft way direction respectively shows stretch of less than 3% which is very low and recovery from stretch of close to 100%. The laminate as above with 100% cotton spun yarn based fabric, whose construction is derived from above fabric but suitable for easy deformation, shows stretch of 18% to 20% and instant recovery of more than 80%. After 24 hours, recovery is close to 100% meaning growth of 0%.

Membrane selected for invention is either non breathable or breathable depending upon application and water repellent thereby inculcating water/liquid and gas/air barrier or permeable properties to the product. By virtue of the elasticity of the membrane, the fabric acquires a wrinkle free behavior, meaning, once the distorting force is removed fabric reverts back to flat look. The membrane strength and adhesive, adds to the strength of the yarns, and consequently fabric strength.

Since, the adhesive used for binding does not penetrate in to the complete thickness of fabric, original attributes of non-bound face such as, touch, look, feel and absorbency are preserved. Furthermore, partially penetrated adhesive improves the tensile strength of the fabric by improved grouping and bonding of fibers in the yarns. So strengthened yarns improve the tear strengthen of the fabric. These properties improve the durability of product

It has been found that the laminate of instant invention has a Durable Press Rating of 4, thereby inculcating the property of being wrinkle-free. Further, it is also observed that said laminate needs hydrostatic head of 12 mm so that water passes through the product. This level of hydrostatic head is not seen in any apparel or home or upholstery application meaning, said laminate is a barrier for water to pass through. It is also observed that laminate of instant invention with non breathable membrane has an air permeability of less the 0.14 cm/cm²/sec, meaning, laminate is air impermeable.

Since, the multipurpose stretchable fabric product involves independent production and processing of the non-stretchable fabric till finishing, one can use any suitable yarn counts and construction of fabric meeting above requirements.

In preferred embodiment, the invention provides a multipurpose laminated stretch fabric suitable for home textiles and apparels and other personal and industrial applications comprising a non-stretchable element adhesively bound to a stretchable element on remote side.

A multipurpose laminated stretch fabric of invention wherein the non-stretchable element comprises a woven, easily deformable fabric comprising openly spaced warp yarns intersecting at right angles with a plurality of more openly and parallelly spaced apart weft yarns or easily deformable knitted fabric having a single jersey or interlock construction. The non-stretchable fabric as used herein has yarn count in range of Ne 20/1 to Ne 120/1. Further, the non-stretchable element comprises spun yarn or filament yarn having a warp density of about 52 to 300 per inch and weft density of around 35 to 300 per inch and weight in range of 60 to 220 g/m².

The laminate of invention further comprises of a stretchable element wherein, the stretchable element is a membrane of polyurethane or thermoplastic polyurethane having a thickness of around 20 microns to 40 microns and weight in range of 25 g/m² to 40 g/m². Furthermore, the stretchable element provides water/liquid and/or air/vapor barrier.

In yet another embodiment, the invention provides for an assembly for manufacturing the multipurpose laminated stretch fabric of instant invention comprising a pre-tensioning device 8 for stretching the stretchable membrane (20) from roll 1, wherein the stretchable membrane (20) is layered with release paper, an applicator roll 3 for application of adhesive to stretchable membrane (20), a tensioning device 7 for pre-tensioning the non-stretchable fabric (10) from roll 2, a lamination roll 4 for laminating the non-stretchable fabric (10) and stretchable membrane (20) under desired pressure to get the multipurpose laminated stretch fabric.

In yet another embodiment, the instant invention provides for process for manufacturing of the laminate. Said process comprises following steps:
a. Pre-tensioning of membrane (20) from membrane roll (1) with a stretching assembly (8);
b. Applying of suitable adhesive to pre-tensioned membrane of step (a), on at least one side, by applicator roll (3);
c. Pre-tensioning the fabric (10) from fabric roll (2) with tensioning assembly (7);
d. Laminating the pre-tensioned membrane of step (a) and step (b) and pre-tensioned fabric of step (c), at least on one side with membrane, under specific conditions by lamination roll (4); and
e. Curing laminated product of step (d) at room temperature.

The instant invention is more specifically explained by following examples. However, it should be understood that the scope of the present invention is not limited by the examples in any manner. It will be appreciated by any person skilled in this art that the present invention includes following examples and further can be modified and altered within the technical scope of the present invention.

### EXAMPLES

### Example 1

With reference to FIG. 2a and FIG. 2b, the figures show the laminate of instant invention comprising a non-stretchable element 10 bound adhesively to stretchable element 20. The non-stretchable element 10 comprises an easily deformable woven fabric, consisting of openly spaced warp yarns intersecting at right angles to more openly and parallelly spaced weft yarns. The yarns used herein are non-stretchable spun yarn having a warp density in range of 68 to 100 per inch and weft density in range of 29 to 50 per inch and weight in range of 100 to 140 g/m². Further, the non-stretchable element has yarn counts in range of Ne 20/1 to Ne 40/1. The stretchable element 20 comprises of a polyurethane or thermoplastic polyurethane membrane having a thickness in range of 12μ to 40μ and weight in range of 25 g/m² to 40 g/m2.

### Process for Production of Example 1

The process for manufacturing the lamination of instant invention comprises of spinning of the staple fiber, followed by weaving of the spun yarn. The woven fabric is further dyed and processed. The dyed and finished non-stretchable element is further processed for lamination.

The lamination process comprises of pre-tensioning the stretchable element with tensioning device and application of adhesive to the stretchable element and proceeded to lamination roll. The woven non-stretchable element is pre-tensioned by the pre-tensioning assembly and preceded to lamination roll. At the lamination roll both, the pre-tensioned stretchable element having adhesive applied on one side and the non-stretchable element are pressed together under specific conditions of pressure in the range of 5 to 25 kg/cm2. Finally, the laminate of current invention is cured at room temperature to get final laminate of invention.

Following Table 1 depicts the test results of Stretch fabrics produced using easily deformable woven fabrics.

TABLE 1
Woven Stretch Materials

| | | Stretch | Stretch After | |
|---|---|---|---|---|
| | | After | Applying | Recovery after |
| | Picks | Specific | specific | growth by |
| | Per | Tension | tension | extension |
| ITS No. | inch | % | % | % |
| 15254 | 48 | 18.1 | 19.3 | 83.7 |
| 15261 | 38 | 18.9 | 19.9 | 82.9 |
| 15265 | 29 | 18.1 | 19.1 | 83.7 |
| 15264 | 48 | 18.5 | 19.9 | 82.2 |

### Example 2

The laminate as described in example 1, wherein the non-stretchable element 10 comprises of woven fabric made of filament yarns.

### Process for Production of Example 2

The process for manufacturing the lamination of instant invention comprises extrusion of filament yarn, followed by draw texturing of extruded filament yarn, followed by weaving of the draw textured filament yarn. The woven filament yarn fabric is further dyed and finished. The dyed and finished non-stretchable element is further processed for lamination.

The process for lamination is same as described in example 1.

### Example 3

The laminate as described in example 1, wherein the non-stretchable element 10 comprises of knitted fabric made out of staple fiber spun yarn.

### Process for Production of Example 3

The process for manufacturing the lamination of instant invention comprises of spinning of staple fiber, followed by knitting of the staple fiber yarn thereby forming a knitted fabric. The knitted fabric is further dyed and finished. The dyed and finished element is further processed for lamination.

The process for lamination is same as described in example 1.

Following Table 2 depicts test results of Stretch fabrics produced using knitted fabrics. Tests are performed using 10 lb load.

TABLE 2
Knitted Stretch Materials:

| | | Length way | | | Width way | | |
|---|---|---|---|---|---|---|---|
| | | 35% Growth | | | 60% Growth | | |
| | | After | | Stretch | After | | Stretch |
| | Laminated | 30 | | after | 30 | | after |
| ITS No. | face | sec | 60 sec | 5 lb | sec | 60 sec | 5 lb |
| 15268 | Single | 5.1 | 2.8 | 11 | 15.4 | 10.6 | 35 |

### Example 4

The laminate as described in example 1, wherein the non-stretchable element 10 comprises of knitted fabric made out of filament yarns.

### Process for Production of Example 4

The process for manufacturing the lamination of instant invention comprises of extrusion of filament yarn, followed by draw texturing of extruded filament yarn, followed by knitting of the draw textured filament yarn. The knitted filament yarn fabric is further dyed and finished. The dyed and finished element is further processed for lamination.

The process for lamination is same as described in example 1.

### Example 5

The laminate as described in example 1 wherein, the stretchable membrane 20 is sandwiched between two fabrics 13 and 14 which are easily deformable.

### Process for Production of Example 5

The process for manufacturing the lamination of instant invention comprises of spinning of staple fiber, followed by knitting or weaving of the staple fiber yarn there by formation of easily deformable knitted or woven fabric respectively. The knitted or woven fabric is further dyed and finished. The dyed and finished element is further processed for lamination.

One of the sides of easily deformable element is laminated with stretchable membrane using a process similar to one described for lamination in example 1. After, room temperature curing, this laminated product is further laminated with another easily deformable element. This lamination is carried out on the freely exposed side of the stretchable membrane.

Following Table 3 depicts test results of Stretch fabrics produced as per example 5. Tests are performed using 10 lb load.

TABLE 3
Knitted Sand-witched Stretch Materials:

| | | Length way | | | Width way | | |
|---|---|---|---|---|---|---|---|
| | | 35% Growth | | | 60% Growth | | |
| | | After | | Stretch | After | | Stretch |
| | Laminated | 30 | | after | 30 | | after |
| ITS No. | Face(s) | SEC | 60 SEC | 5 lb | SEC | 60 SEC | 5 lb |
| 15272 | Double | 6.7 | 4.3 | 22.4 | 16.9 | 12.6 | 68.9 |

### Example 6

Table 4 below depicts the air barrier properties, water barrier properties, wrinkle free properties, tensile strength properties of stretch material of instant invention.

TABLE 4
Stretch Fabric Test Report - Tested At InterTek

| | TESTING | | | Sample No. | | | | |
|---|---|---|---|---|---|---|---|---|
| | PARAMETER | Protocol | Standard | 1 | 2 | 3 | 4 | 5 |
| A | Air | ASTM- | 0 | <0.14 | <0.14 | <0.14 | <0.14 | <0.14 |
| | Permeability | D737-96 | | | | | | |
| | (cm/cm2/sec) | | | | | | | |
| B | Hydrostatic | | 8 | 12900 | 12595 | 11920 | 13640 | 12165 |
| | Pressure(mm) | | | | | | | |
| C | Tensile | ASTM | | | | | | |
| | Strength | D5034 | | | | | | |
| | Warp (LBS) | | 30 | 72 | 72.8 | 70.4 | 74 | 79.3 |
| | Weft (LBS) | | 20 | 34.5 | 34.8 | 26 | 21.8 | 14.9 |
| D | Tearing | ASTM | | | | | | |
| | Strength | D1424 | | | | | | |
| | Warp (LBS) | | 2.5 | 3.4 | 3.2 | 3.7 | 4.5 | 3.8 |
| | Weft (LBS) | | 1.4 | 1.5 | 1.5 | 1.5 | 1.6 | 1.9 |
| G | D.P rating | AATCC | 3+ | 4 | 4 | 4 | 4 | 4 |
| | | 124 | | | | | | |

We claim:

1. A multipurpose laminated stretch fabric for home textiles, upholstery, apparels, personal applications, and industrial applications comprising: at least one non-stretchable fabric adhesively bound to a stretchable membrane on at least one side

2. The multipurpose laminated stretch fabric as claimed in claim 1, wherein the non-stretchable fabric comprises a woven, easily deformable fabric having parallel-spaced warp yarns intersecting at right angles with a plurality of parallel-spaced apart weft yarns, wherein the warp and weft yarn spaces define deformability in the woven fabric.

3. The multipurpose laminated stretch fabric as in claim 1, wherein the easily deformable fabric comprises knitted fabric having a single jersey or interlock construction.

4. The multipurpose stretch fabric as claimed in claim 1, wherein the stretchable membrane is a membrane of polyurethane or thermoplastic polyurethane laminated to a remote side of said stretchable fabric.

5. The multipurpose laminated stretch fabric as in claim 1, wherein the non-stretchable fabric is formed using yarn counts in range of Ne 20/1 to Ne 120/1.

6. The multipurpose laminated stretch fabric as in claim 2, wherein the non-stretchable fabric comprises non-stretchable spun yarn or filament yarn having a warp density in range of 52 to 300 per inch and weft density in range of 35 to 190 per inch and weight in range of 60 to 220 g/m².

7. The multipurpose laminated stretch fabric as in claim 4, wherein the stretchable membrane has a thickness in range of 20 microns to 50 microns and weight in range of 25 g/m² to 40 g/m².

8. The multipurpose laminated stretch fabric as in claim 1, wherein a water/liquid barrier and/or air/vapor barrier is provided by the stretchable membrane.

9. An assembly for manufacturing the multipurpose laminated stretch fabric of claim 1 comprising:
a pre-tensioning device for stretching a stretchable membrane from a first roll, wherein the stretchable membrane is layered with release paper;
an applicator for application of adhesive to the stretchable membrane;
a tensioning device for pre-tensioning a non-stretchable fabric from a second roll; and
a lamination roll for laminating the non-stretchable fabric on at least one side to the stretchable membrane under a desired pressure to obtain the multipurpose laminated stretch fabric.

10. The process for manufacturing the multipurpose laminated stretch fabric of claim 1 which comprises:
a. pre-tensioning of a membrane from a membrane roll with a first pre-tensioning device;
b. applying an adhesive to the pre-tensioned membrane of step (a) on at least one side by an applicator roll;
c. pre-tensioning a fabric from a fabric roll with a second pre-tensioning device;
d. laminating the pre-tensioned membrane of step (b) and the pre-tensioned fabric of step (c) under pressure in the range of 5 to 25 kg/cm², on at least one side of the pre-tensioned membrane with a lamination roll; and
e. curing laminated product of step (d) at room temperature to obtain the multipurpose laminated stretch fabric.
